(19) United States
(12) Patent Application Publication
(10) Pub. No.: US 2005/0063207 A1
(43) Pub. Date: Mar. 24, 2005

(54) Multifunction car charger connector

(76) Inventor: Wen Feng Tsay, Taipei (TW)

Correspondence Address: WEN FENG TSAY, P.O. BOX 24-108, TAIPEI, TW

(21) Appl. No.: 10/666,757

(22) Filed: Sep. 22, 2003

(51) Int. Cl. H02M 1/00

(52) U.S. Cl. 363/145

(57) ABSTRACT

A multifunction car charger connector comprising a pedestal and an attachment shell; the pedestal is in a body structure to have a charger connector connect to the cigarette lighter; a circuit board contains a charging circuitry for mobile phones, PDA's or handheld games is on a converter inside the pedestal; a clip slot is on the converter to wedge the shell attachment that has a container for fragrant materials; the container inside the shell attachment can be a box for fragrant materials or appliances that need power such as anion generator, ozone sterilant, ultraviolet disinfection, titania or fragrant evaporator, these devices can connect to the circuitry inside the pedestal by plug-in or contact through a conductive plate; a plug-in connector is on the pedestal to connect to mobile phones, PDA's or handheld games by a connecting cable, the fragrant materials inside the attachment shell ensure fresh air, needs of the hygienic requirement inside an automobile.

### BACKGROUND OF THE INVENTION

I. Field of the Invention

This invention relates generally to a car charger connector and, more specifically, to a multifunction car charger connector that plugs in the cigarette lighter of an automobile and connect to a circuit board inside the charger, a converter is installed inside to charge and carry out handsfree functions of mobiles phone, PDA's and hand held games connected. An attachment with container for fragrant materials can be wedge to the pedestal and forms a connection with the cigarette lighter. A plug-in connector can connect to mobiles phone, PDA's and hand held games through a cable to charge and carry out handsfree functions as well. The fragrant materials inside the attachment shell ensure fresh air, needs of the hygienic requirement inside an automobile.

II. Description of the Prior Art

Heretofore, it is known that mobile phones, PDA's and hand held video games are getting more and more popular; these appliances are very convenient for people while they go outdoors. Most of the automobiles have a charger and a converter for battery charging and handsfree functions. However most of those converters are designed for single function; with the limited number of cigarette lighter inside an automobile, other appliances are not available without power. In order to offer better air quality, disinfection and safety, many fragrant aromatic, ozone sterilant, ultraviolet disinfection, titania or fragrant evaporator are applied for hygienic purpose; however with only single power charger and limited space inside an automobile is not enough for all the appliances, an apparatus is needed to have everything in order.

### SUMMARY OF THE INVENTION

It is therefore a primary object of the invention to provide a multifunction car charger connector to plug in the cigarette lighter and form a connection for battery charging and handsfree functions; an attachment shell with a internal container to install fragrant materials for fresh air.

In order to achieve the objective set forth, a multifunction car charger connector in accordance with the present invention comprises a pedestal and an attachment shell; the pedestal is in a body structure to have a charger connector connect to the cigarette lighter; a circuit board contains a charging circuitry for mobile phones, PDA's or handheld games is on a converter inside the pedestal; a clip slot is on the converter to wedge the shell attachment that has a container for fragrant materials; the container inside the shell attachment can be a box for fragrant materials or appliances that need power such as anion generator, ozone sterilant, ultraviolet disinfection, titania or fragrant evaporator, these devices can connect to the circuitry inside the pedestal by plug-in or contact through a conductive plate; a plug-in connector is on the pedestal to connect to mobile phones, PDA's or handheld games by a connecting cable.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is an assembly view of the present invention.

### DESCRIPTION OF THE PREFERRED EMBODIMENT

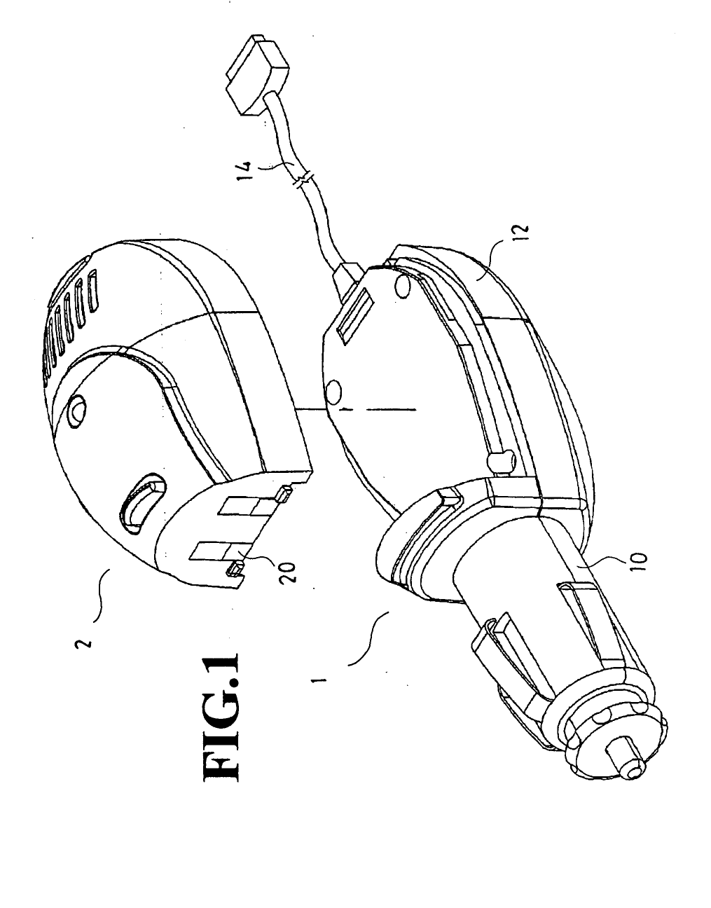

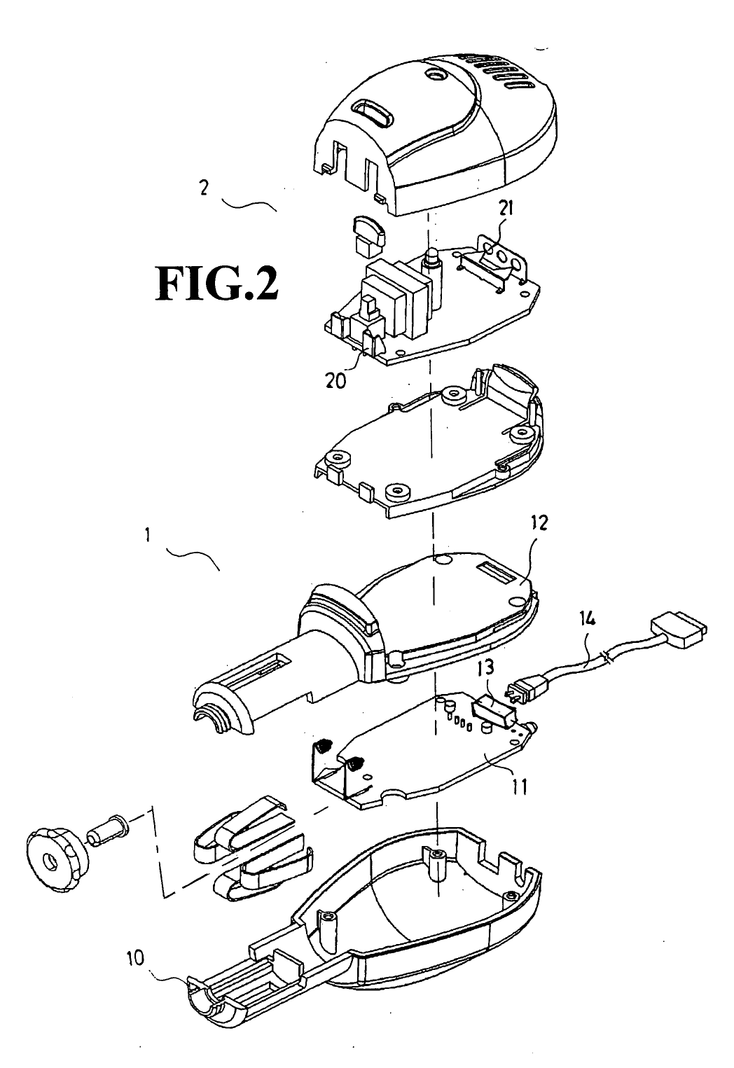

Referring to FIG. 1 and FIG. 2, the present invention is composed of a pedestal (1) and an attachment shell (2); the pedestal (1) is in a body structure to have a charger connector (10) connect to the cigarette lighter; a circuit board (11) contains a charging circuitry for mobile phones, PDA's or handheld games is on a converter (12) inside the pedestal (1); a clip slot is on the converter (12) to wedge the shell attachment (2) that has a container for fragrant materials; the container inside the shell attachment (2) can be a box for fragrant materials or appliances that need power such as anion generator (21) (as shown in FIG. 2), ozone sterilant, ultraviolet disinfection, titania or fragrant evaporator, these devices can connect to the circuitry inside the pedestal (1) by plug-in or contact through a conductive plate (20); a plug-in connector (13) is on the pedestal (1) to connect to mobile phones, PDA's or handheld games by a connecting cable (14).

In real application, users can plug in the charger connector (10) of the pedestal (1) and connect to the cigarette lighter that connects the mobile devices to automobile circuitry; when the mobile phones, PDA's or handheld games need to be charged or for handsfree function, users can apply the plug-in connector (13) and the connecting cable (14) to have the mobile phones, PDA's or handheld games connect to the pedestal (1); by the control and output of the circuit board (11) inside the pedestal (1), these appliances can be charged or handsfreed; at the same time, the fragrant materials inside the attachment shell (2) above the converter (12) of the pedestal (1) can have the fragrant materials refresh the air quality; the fragrant materials or anion generator (21), ozone sterilant, ultraviolet disinfection, titania, fragrant evaporator can connect to the circuit board (11) inside the pedestal (1) through the conductive plate (20) to function these appliances for better hygienic condition inside the automobiles.

While a preferred embodiment of the invention has been shown and described in detail, it will be readily understood and appreciated that numerous omissions, changes and additions may be made without departing from the spirit and scope of the invention.

1. A multifunction car charger connector comprising:
a pedestal in a body structure to have a charger connector connecting to the cigarette lighter, a circuit board contains a charging circuitry for mobile phones, PDA's or handheld games is on a converter inside said pedestal;
a shell attachment having a container for fragrant materials;

2. The multifunction car charger connector recited in claim 1, wherein said shell attachment having a conductive plate to connect to the circuitry inside said pedestal by plug-in or contact when said shell attachment being wedged with said pedestal.
